(19) United States
(12) Patent Application Publication
(10) Pub. No.: US 2025/0350448 A1
(43) Pub. Date: Nov. 13, 2025

(54) System and Method for Remote Probabilistic Secret Key Distribution

(71) Applicant: Anametric, Inc., Austin, TX (US)

(72) Inventors: Mitchell A. THORNTON, Dallas, TX (US); William V. OXFORD, Austin, TX (US)

(21) Appl. No.: 18/595,747

(22) Filed: Mar. 5, 2024

Related U.S. Application Data
(60) Provisional application No. 63/489,617, filed on Mar. 10, 2023.

(51) Int. Cl. H04L 9/08

(52) U.S. Cl. CPC H04L 9/0852; H04L 9/085; H04L 9/0872

(57) ABSTRACT

Embodiments of systems and methods for systems and methods for remote probabilistic secret key distribution that may be utilized for Quantum Key Distribution (QKD) are disclosed. In particular, embodiments of a secret key distribution system as presented herein may utilize an architecture that includes a photonic entropy source. Such a photonic entropy source may be utilized to produce photon sequences at randomly distributed time intervals. Embodiments may utilize this random sequence of time intervals of the production of photons as a source of entropy for provisioning shared secret keys.

### RELATED APPLICATIONS

This application claims a benefit of priority under 35 U.S.C. § 119 to U.S. Provisional Patent Application No. 63/489,617 filed Mar. 10, 2023, entitled “System and Method For Remote Probabilistic Secret Key Distribution”, by Mitchell A. Thornton and William V. Oxford, which is hereby fully incorporated by reference in its entirety.

### TECHNICAL FIELD

This disclosure relates generally to provisioning secret keys shared between devices. In particular, this disclosure relates to quantum photonic key distribution. Even more specifically, this disclosure related to embodiments of multi-source, extractor based, provisioning of shared secret keys between devices.

### BACKGROUND

Quantum Key Distribution (QKD) is a revolutionary cryptographic technique that uses principles of quantum mechanics to securely distribute a value that can be utilized as the basis of a shared secret (also referred to interchangeably as a shared key, secret key or shared secret key) between computing devices (or applications executing thereon). The most common application of QKD is in the generation and distribution of cryptographic keys for secure communication between such computing devices. For example, QKD can be utilized for secure communication in scenarios where the confidentiality of information is critical, such as in secure government communications or financial transactions.

QKD relies on the principles of quantum mechanics, particularly the behavior of quantum particles like photons. In QKD the quantum particles (e.g., individual photons) are typically used as quantum bits to carry information. To illustrate in more detail, a QKD process involves the exchange or measurement of quantum states between two parties, often referred to as Alice and Bob. In a typical QKD process, Alice sends a series of encoded photons to Bob, and they both measure the polarization states of these photons in order to accomplish the transfer of confidential data between Alice & Bob.

Bob randomly measures the polarization states of the received photons and communicates the basis used for each measurement to Alice. Alice then informs Bob of the correct basis to use for each measurement. Both parties discard measurements made with the wrong basis, keeping only the measurements made with the correct basis. These measurements of the polarization states can then be used as a basis for a secret key that is shared between Alice and Bob. This secret key can then be used with an encryption algorithm to encrypt and decrypt data between Alice and Bob.

By leveraging the principles of quantum mechanics to enable the secure exchange of cryptographic keys, QKD offers a level of security that is theoretically impossible to achieve using classical cryptographic methods. Namely, QKD provides information-theoretic security, meaning the security is based on fundamental principles of physics, not on the computational difficulty of solving a mathematical problem. Moreover, detection of eavesdropping attempts is possible due to the principles of quantum mechanics. For example, any attempt by an eavesdropper (Eve) to intercept the quantum states of the photons passing between Alice and Bob (and thus deriving the secret key) will be detectable, as the very act of measuring the quantum states of the photons passing between Alice and Bod would disturb the quantum states of those photons.

While QKD is thus useful and powerful, there are certain problems with QKD. Many of these have to do with the complexity of implementation. In particular, most QKD is dependent on measurement of the quantum state of a quantum information carrier (e.g., in a preparation and measurement based protocol or an entanglement based protocol). Thus, the implementation of such QKD systems may be quite hardware or processor intensive, among other drawbacks.

What is desired are simpler systems and methods for implementing QKD.

### SUMMARY

To address these needs, among others, attention is directed to embodiments of systems and methods for remote probabilistic secret key distribution that may be utilized for Quantum Key Distribution (QKD). In particular, embodiments of a secret key distribution system as presented herein may utilize an architecture that includes a photonic entropy source where a source of physical entropy may be derived from the quantum photonic source. Such a quantum photonic source may be utilized to produce photon sequences at randomly distributed time intervals (e.g., as well as random superimposed quantum states in some cases). Thus, a random sequence of time intervals of the production of photons, and the randomness present in measurements of a superimposed quantum state based on those photons, may be utilized as simultaneous, but independent, sources of entropy for provisioning shared secret keys. Such a superimposed quantum state may be created, for example, by passing the photon or some other quantum information carrier through a quantum logic gate such as a Hadamard gate or Chrestenson gate.

Another possible source of entropy can be generated by pairs of photons created in the photon pair generator and generated via the Four Wave Mixing (FWM) or a Spontaneous Parametric Down Conversion (SPDC) process. In one embodiment, for example, a photon pair generator may include a laser adapted to excite a spontaneous parametric down conversion (SPDC) device to generate a heralded single photon source in the form of a signal and idler (also referred to as a trigger) photon pair.

A photon pair generator (e.g., a single photon source used to provide a signal and idler photon pair) may thus be used to produce pairs of photons that are time coincident (e.g., are produced, or emitted, at the same time). These photons may also be produced in a probabilistic manner (e.g., non-consistent). In embodiments, for each pair of photons produced by the photon pair generator, one photon (e.g., the signal or idler) of the photon pair may be provided to a first location (e.g., in one embodiment kept locally on the system including the photon pair source, such as on a chip, circuit or device), while the other photon of the photon pair (e.g., the signal or idler photon) generated by the photon pair generator may be sent to a remote channel or location (e.g., to another system or device, or another portion of the chip, circuit or device, etc.).

According to one embodiment then, each production of a photon pair from a photon pair source may result in a (e.g., random) duration that can be determined from measuring the time interval between the production of a detected photon and the detection of a previously detected photon. After some number of (e.g., N) photons are produced by the photon pair source, a set of (e.g., N) time intervals determined from measuring the time intervals between the production of these photons may be determined at both locations. This set of time intervals may thus be a set of (e.g., N) random values that may be the same at both locations that may be used as the basis for determining a secret that can be shared by these locations.

To illustrate in more detail, at each location the successive time intervals between each of the respective photons may be measured. Such a determination may be made, for example, by providing a waveguide for conducting such a photon from the photon pair source to a photodetector at each location that is coupled to a clock circuit or counter, etc. For example, the idler photon of the photon pair produced by a photon pair generator may be kept locally such that time intervals between successive idler photons produced by the photon pair generator may be measured locally to produce a local series of time intervals based on the idler photons produced by the photon pair generator. Similarly, the signal photon of the photon pair produced by a photon pair generator may be sent to the remote location such that time intervals between successive signal photons produced by the photon pair generator may be measured at the remote location to produce a remote series of time intervals based on the signal photons produced by the photon pair generator.

As each pair of photons produced by the photon pair generator may be produced at substantially the same time, the local series of time intervals and remote series of time intervals based on measuring the time intervals between successive photons of different ones of the pairs of photons produced by the same photon pair generator should be substantially equivalent. Thus, the local series of time intervals or remote series of time intervals can be utilized as a shared secret or key (again, used interchangeably) between the local and remote location, or utilized as a basis to derive a shared secret or key at the local and remote location. This shared secret can then be used in cryptographic algorithms or the like to secure data passing between the two locations.

Accordingly, embodiments may provide a remote shared secret or key provisioning mechanism based on generation and distribution of time synchronized photon pairs and specifically, for using photon pair production intervals as a basis for establishing a series of time periods (e.g., intervals) for secret key provisioning on different devices (or different areas of the same device, etc.). These shared secrets or keys can be verified in a variety of ways such as checking portions of the time periods, checking a hash created with the set of time periods or a hash created with the secret key, etc.

Embodiments of such key distribution systems may be implemented, for example, on a hybrid integrated circuit containing both photonic and digital processing where the key determination functions are implemented either within an on-chip circuitry such as in digital logic or in or embedded electronic processor core or by some other combination of hardware and software.

Embodiments as presented herein thus may allow the sharing of a secret key using simpler methodologies based on the detection of photons and the time intervals between such photons, allowing the distribution of a key based on quantum properties without actual measurement of the quantum state of a quantum information carrier.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a block diagram of an architecture for a Quantum Key Distribution (QKD) system according to embodiments.

FIG. 2 is a block diagram of a specific implementation of an embodiment of a QKD computing device.

FIG. 3 is a flow diagram of one embodiment of a method for QKD.

### DETAILED DESCRIPTION

The disclosure and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before discussing embodiments in more detail, it may be helpful to give a general overview of certain aspects pertaining to embodiments. As discussed, Quantum Key Distribution (QKD) is a mechanism that uses principles of quantum mechanics to securely distribute a value (such as a set of bit values) that can be utilized as a shared secret between computing devices (or applications executing thereon). This shared key can then be used as the basis for the implementation of cryptographic security measures (e.g., encryption of data passing between the devices). QKD is therefore extremely useful in a high security environment. Namely, by leveraging quantum mechanics to securely exchange cryptographic keys, QKD offers a level of security that is theoretically impossible to achieve using classical cryptographic methods. Moreover, detection of eavesdropping attempts is possible due to these same quantum principles. The implementation of QKD can, however, be complex. It is thus desired to simplify the implementation of QKD systems and methods.

Embodiments may therefore provide simplified systems and methods for remote probabilistic secret key distribution that may be utilized for QKD. In particular, embodiments of a secret key distribution system as presented herein may utilize an architecture that includes a photonic entropy source including a photon pair generator to produce pairs of photons that are time coincident (e.g., are produced, or emitted, at the same time), where those pairs of photons are produced in a probabilistic manner (e.g., non-consistently produced) such that the time interval between the production of pairs of photons is random.

According to embodiments, for each pair of photons produced by the photon pair generator, one photon (e.g., the signal or idler) of the photon pair may be provided to a first location (e.g., in one embodiment kept locally on the system including the photon pair source, such as on a chip, circuit or device), while the other photon of the photon pair (e.g., the signal or idler photon) generated by the photon pair generator may be sent to a remote channel or location (e.g., to another system or device, or another portion of the chip, circuit or device, etc.).

According to one embodiment then, each production of a photon pair from a photon pair source may result in a (e.g., random) duration that can be determined from measuring the time interval between the production of a detected photon and the detection of a previously detected photon. After some number of (e.g., N) photons are produced by the photon pair source, a set of (e.g., N) time intervals determined from measuring the time intervals between the production of these photons may be determined at both locations. This set of time intervals may thus be a set of (e.g., N) random values that may be the same at both locations that may be used as the basis for determining a secret that can be shared by these locations.

To illustrate in more detail, at each location the successive time intervals between each of the respective photons may be measured. Such a determination may be made, for example, by providing a waveguide for conducting such a photon from the photon pair source to a photodetector at each location that is coupled to a clock circuit or counter, etc. For example, the idler photon of the photon pair produced by a photon pair generator may be kept locally such that time intervals between successive idler photons produced by the photon pair generator may be measured locally to produce a local series of time intervals based on the idler photons produced by the photon pair generator. Similarly, the signal photon of the photon pair produced by the photon pair generator may be sent to a remote location such that time intervals between successive signal photons produced by the photon pair generator may be measured at the remote location to produce a remote series of time intervals based on the signal photons produced by the photon pair generator.

As each pair of photons produced by the photon pair generator may be produced at substantially the same time, the local series of time intervals and remote series of time intervals based on measuring the time intervals between successive photons of different ones of the pairs of photons produced by the same photon pair generator should be substantially equivalent. Thus, the local series of time intervals and remote series of time intervals can be utilized as a shared secret between the local and remote location, or utilized as a basis to derive a shared secret at the local and remote location. This shared secret can then be used as the basis for the implementation of cryptographic security measures to, for example, secure data passing between the local and remote locations (e.g., for encryption of data passing between the devices).

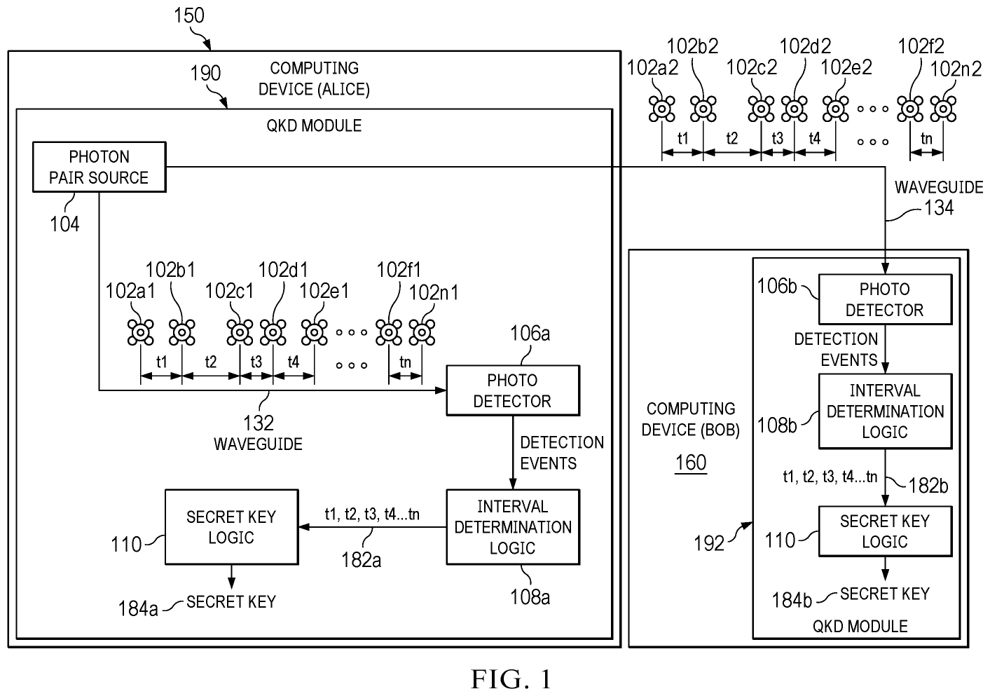

Turning now to FIG. 1, a block diagram of one embodiment of a QKD system that utilizes time intervals between the production of pairs of photons to distribute a secret key between computing devices is depicted. Each computing device 150, 160 includes a respective QKD module 190, 192 for determining a shared secret between the computing devices 150, 160. QKD module 190 at one computing device 150 (e.g., referred to herein as Alice's computing device without loss of generality) may include a photon pair source 104. In one embodiment, a photon pair source 104 may include a laser exciting a spontaneous parametric down conversion (SPDC) device to generate a heralded single photon in the form of a signal and idler photon pair. For example, a photon pair source 104 may be comprised of a pulsed laser source with, for example, wavelength 405 nm serving as a pump and a rotatable half-wave plate (HWP) for adjusting the angle of linear polarization of the pump photon with the optical axis of the SPDC. The down-converted signal and idler photons are at, for example, 810 nm wavelength.

One output of photon pair source 104 (e.g., the output for the idler photon) is coupled to photodetector 106a at Alice's computing device 150 through waveguide 132 (e.g., an optic fiber or the like), while the other output of photon pair source 104 (e.g., the output for the signal photon) is coupled to photodetector 106b of QKD module 192 at Bob's computing device 160 through waveguide 134. These photodetectors 106 can be, for example, single photon avalanche diodes (SPADs). Thus, one photon 102 (e.g., 102a1) of a photon pair 102a-120n (e.g., 102a) emitted by photon pair source 104 (e.g., the idler photon) is conducted on waveguide 132 to (local) photodetector 106a at Alice's computing device 150, whereas the other photon 102 (e.g., 102a2) of the photon pair 102a-120n (e.g., 102a) produced by the photon pair source 104 (e.g., the signal photon) is conducted on waveguide 134 to photodetector 106b at Bob's computing device 160.

Photodetector 106a at Alice's computing device 150 is adapted to detect the presence of (e.g., a single) photon 102 on waveguide 132 and output a detection event to interval determination logic 108a of QKD module 190. Similarly, photodetector 106b at Bob's computing device 160 is adapted to detect the presence of (e.g., a single) photon 102 on waveguide 134 and output a detection event to interval determination logic 108b of QKD module 192. Interval determination logic 108 (which may be, or include, a clock circuit, counter, or the like) may be adapted to determine a time period (value) reflective of a time interval between reception of detection events from photodetector 106. The reception of a detection event at interval determination logic 108 may serve to reset or (re)start such interval determination logic 108, and to cause an output of any previously determined time period (e.g., a time period determined between reception of a previous detection event and the current detection event) to secret key logic 110.

Secret key logic 110 of QKD modules 190, 192 may thus be adapted to receive (e.g., and store) one or more time periods received from interval determination logic 108 and use this set of received time intervals to generate a secret key (value) 184. For example, secret key logic 110 may be configured to determine a secret key 184 (e.g., after reset or initialization, etc.) when a certain number of time intervals have been received or when a certain number of photons 102 have been detected by photo detector 106. This number of time intervals of photons 102 may, for example, be configurable. The secret key 184 may be, for example, the time periods (t1-tn) themselves or a value derived from time periods (t1-tn).

In operation then, photon pair source 104 of QKD module 190 at Alice's computing device 150 may be caused to generate a number of photon pairs (102a-102n). The number of photon pairs (102a-102n) generated may be configurable such that both QKD module 190 at Alice's computing device 150 and QKD module 192 at Bob's computing device 160 are aware of the number. As discussed, photons 102 (e.g., 102a1, 102a2) of each photon pair (102a-102n) (e.g., pair 102a) are time coincident (e.g., are produced, or emitted, by photon source 104 at the same time), where those pairs (102a-102n) of photons 102 are produced in a probabilistic manner (e.g., non-consistently produced) such that the time interval between the production of pairs (102a-102n) of photons 102 is random. Thus, the time intervals (t1-tn) between successive (e.g., idler or signal) photons 102 (of each photon pair 102a-102n) may be different and random.

As each (e.g., idler) photon 102a1-102n1 of each produced photon pair (102a-102n) is received (e.g., detected) at the photodetector 106a of Alice's computing device 150 over waveguide 132, detection events are generated by photodetector 106a and provided to interval determination logic 108a. Interval determination logic 108a at Alice's computing device 150 may thus output a set 182a of time periods (t1-tn) based on the determined time periods between reception of detection events for (e.g., idler) photons 102a1-102n1 of photon pairs (102a-102n) at photodetector 106a.

In the same manner, as each (e.g., signal) photon 10a2-102n2 of each produced photon pair (102a-102n) is received at the photodetector 106b of Bob's computing device 160 over waveguide 134, detection events are generated by photodetector 106b and provided to interval determination logic 108b. Interval determination logic 108b at Bob's computing device 160 may thus output a set 182b of time periods (t1-tn) based on the determined time periods between reception of (e.g., signal) photons 102a2-102n2 of photon pairs (102a-102n) at photodetector 106b.

Because photons 102 of each photons pair (102a-102n) are time coincident, as discussed, the set 182a of time periods (t1-tn) determined at Alice's computing device 150 will be the same as the set 182b of time periods (t1-tn) determined at Bob's computing device 160. Accordingly, as secret key logic 110 may be the same or similar at Alice's computing device 150 and Bob's computing device 160, and may determine a secret key based on the same set 182 of time periods (t1-tn) (e.g., time periods having the same value), the secret key 184a determined at Alice's computing device 150 may be the same as the secret key 184b determined at Bob's computing device 160. This secret key 184 can thus be used as the basis for the implementation of cryptographic security measures implemented on Alice's computing device 150 and Bob's computing device 160 (e.g., encryption of data passing between Alice's computing device 150 and Bob's computing device 160).

It will be noted here that for ease of depiction the photon pair source 104 has been depicted as included in Alice's computing device 150. It will be apparent, however, the embodiments include such a photon pair source that is remote from both Alice's computing device 150 and Bob's computing device 160 and such embodiments are fully contemplated herein. In these embodiments, a first photon of each photon pair produced by this remote photon pair source (e.g., idler or signal photon) may be provided to Alice's computing device while a second photon of each photon pair produced by this remote photon pair source (e.g., idler or signal photon) may be provided to Bob's computing device 160. The secret key from these photons from the remote photon source can be determined at Alice's computing device 150 and Bob's computing device 160 as discussed.

As can be seen then, the use of QDK modules 190 at Alice's computing device 150 and QDK module at Bob's computing device 160 may allow a shared secret key 184 to be determined based on simple methodologies that utilize just the detection of photons and the time intervals between such photons, allowing the distribution of a key based on quantum properties without actual measurement of the quantum state of a quantum information carrier. Thus, the shared key 184 may be changed (e.g., redetermined) on a frequent basis with less overhead. According to embodiments, each QDK module 190 (Alice) and QDK module 192 (Bob) may keep a running history of secret keys 184 utilized or determined. This may allow a QDK system to maximize the efficiency of the shared quantum link (e.g., the.

Moreover, in some embodiments, when the photodetector 106b at Bob's computing device 160 reports a photon detection event, then QDK module 192 can add the time difference between the current (single photon detection event) time and the time of a last photon detection event to a list of “candidate” shared secret keys. If QDK module 190 at Alice's computing device 150 also keeps a running count of the time differences between the last several detection events this can be Alice's list of “candidate” shared secret keys. The exact number of detection events that may be kept may be dependent on the quantum efficiency of photodetector 106 detecting photons 102 as well as any impairments in waveguide 134 or a desired quantum key distribution bandwidth.

In some cases, the reason for keeping a list of time deltas is that there will very likely be lost photons (e.g., single-photon detectors are not 100% efficient and there may also be some photons 102 that are absorbed or scattered in waveguide 134). This “photonic loss” can be quantified by running the channel (e.g., waveguide 194) in “classical” communications mode and observing the relative difference in signal strength between the transmitted signal (at Alice's computing device 150) and the received signals (e.g., at Bob's computing device 160). Once that “channel efficiency” (e.g., for waveguide 134) number is known, then it can be used to determine the number of single photon detection events that must be kept in order to satisfy the desired QKD bandwidth.

To illustrate in more detail, assume that Alice (e.g., Alice's computing device 150) sends a series of single photons (P0, P1, P2, P3, etc.) to Bob (e.g., Bob's computing device 160), where the time intervals (e.g., from which the shared secret may be derived) between the successive transmitted photons are expressed as:

shared_key_1 (SK1)=time_interval_1=[time that P1 is received by Bob]−[time that P0 is received by Bob]

shared_key_2 (SK2)=time_interval_2=[time that P2 is received by Bob]−[time that P1 is received by Bob]

shared_key_3 (SK3)=time_interval_3=[time that P3 is received by Bob]−[time that P2 is received by Bob]

When Bob (e.g., QKD module 192 at Bob's computing device 160) detects a single photon event, then the time delta (e.g., equivalent to a shared secret or from which a shared secret may be determined) is reported back to Alice (e.g., QKD module 190 at Alice's computing device 150) using, for example, a standard classical network link. This reporting may not be done directly, but rather by either encrypting the shared secret or by hashing the shared secret value and then sending that hashed value. For example, a first hash value can be generated using (e.g., from or based on) the first secret and a second hash value can be created using the second secret key. The first hash value and the second hash value can then be compared.

However, in the case where a photon is dropped (such that the photon is not received or detected at Bob's computing device 160) (e.g., P2), then the value that Bob (e.g., QKD module 192 at Bob's computing device 160) reports back to Alice (e.g., QKD module 190 at Alice's computing device 150) will be the sum of (time_interval_1)+(time_interval_2). In other words, SK1+SK2.

Alice (e.g., QKD module 190 at Alice's computing device 150) can then determine that Bob has “missed” P2 by the value that Bob (e.g., QKD module 192 at Bob's computing device 160) reports, and then Alice (e.g., QKD module 190 at Alice's computing device 150) replies with a “key agreement” message to Bob (e.g., QKD module 192 at Bob's computing device 160) with the (encrypted) value of SK1+SK2. If Bob (e.g., QKD module 192 at Bob's computing device 160) misses both P2 and P3, then Bob (e.g., QKD module 192 at Bob's computing device 160) will report back to Alice (e.g., QKD module 190 at Alice's computing device 150) the value of SK1+SK2+SK3, which Alice (e.g., QKD module 190 at Alice's computing device 150) will then be able to determine is correct (even though Bob may have missed one or more detection events), since Alice (e.g., QKD module 190 at Alice's computing device 150) has also kept around a running list of candidate shared secrets.

If Alice (e.g., QKD module 190 at Alice's computing device 150) and Bob (e.g., QKD module 192 at Bob's computing device 160) had no list of “candidate” shared secrets, then it may be less likely that QKD modules 190, 192 at Alice's and Bob's computing devices 150, 160 would ever be able to come to an agreement on a mutually shared secret, especially in the case of a “lossy” link or low-efficiency photodetectors (e.g., on both ends). In some cases, the longer the shared secret list is allowed to grow, the more efficient the shared secret transfer mechanism will be. However, if the list of “candidates” is allowed to be too long, then the security of the system may be decreased, because of the increased number of potential “simultaneously valid” shared secrets.

In the case of a rapidly-changing link (e.g., waveguide 134) between Alice's computing device 150 and Bob's computing device 160 (due to, for example, environmental instabilities such as temperature swings, physical movement of the fiber optics, etc.), it may be desirable to have a simultaneous “link health monitor” signal (e.g., that is broadcast over the same transmission channel as the photons sent between QKD modules 190, 192, waveguide 134). This can be accomplished by sending a classical (e.g., not single-photon) signal over the link, but at a slightly different frequency, which can be discriminated at the detector side by a frequency-dependent beam splitter. The difference in frequency between the two signals may be narrow enough that they share the same amount of relative loss through the link, but large enough so that the frequency-splitter can reliably discriminate between the two. In other words, the filters on the receiving end should be of sufficient order that the classical (i.e., multi-photon) signal is attenuated sufficiently that the single-photon detector is not inadvertently triggered by the classical signal.

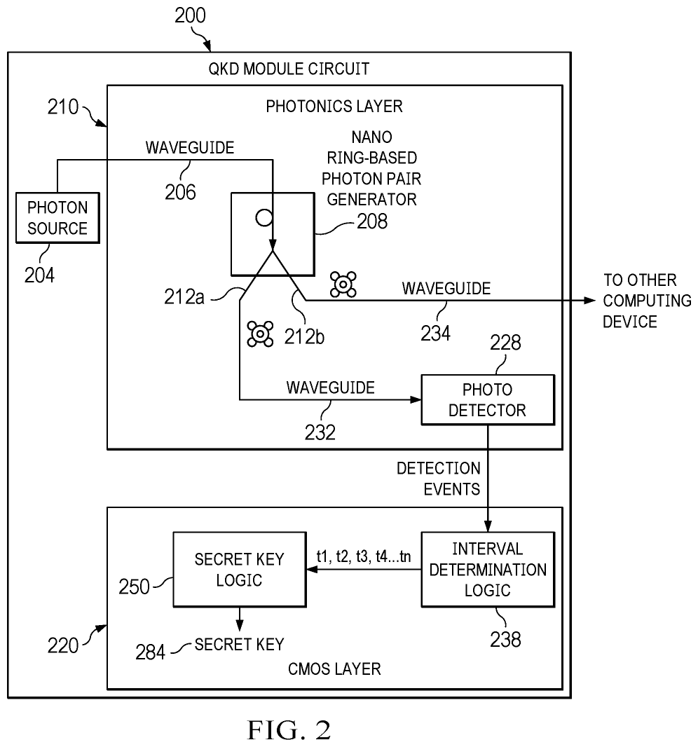

FIG. 2 is a block diagram of a specific implementation of an embodiment of a QKD module implemented on a circuit 200 having photonics layer 210 and a CMOS layer 220. The photonics layer 210 may be coupled to an integrated (e.g., on-chip) or external photon source 204 such that photons emitted from the photon source 204 will be routed to the photonics layer 210 through a waveguide 206. Waveguide 206 may be coupled to a photon pair generator 208 (e.g., an SPDC device) that may, for example, be a nano ring-based photon pair generator.

Photon pair generator 208 may produce a signal and idler photon pair on two outputs 212. One of the outputs 212a (e.g., the idler photon output) may be coupled to photodetector 228 through waveguide 232 on photonics layer 210. The other output 212b of the photon pair generator 208 (e.g., the signal photon output) is coupled to waveguide 234 (which may be coupled to another computing device with which it is desired to share a secret key in a QKD system).

The CMOS layer 220 of the circuit 200 may include RAM or a processor and other processor circuitry as may be desired in various implementations. CMOS layer 220 also includes interval determination logic 238 which may be implemented in hardware, software of some combination of the two and may include a counter or the like. Specifically, photodetector 228 in the photonics layer 210 outputs an electrical signal for a detection event when a photon is detected on waveguide 232. This electrical signal for the detection event is then received at interval determination logic 238 that can, based on the reception of the electrical signal for the detection event, output a determined time period and reset (and start again). In some cases, then, the reception of a detection event at interval determination logic 238 from photodetector 228 may serve to reset or (re)start interval determination logic 238, and to cause an output of any previously determined time period (e.g., a time period determined between reception of a previous detection event and the current detection event) to secret key logic 250 on CMOS layer 220.

Secret key logic 250 on CMOS layer 220 QKD is adapted to receive one or more time periods (t1-tn) from interval determination logic 238 and use this set of time intervals to generate a secret key (value) 284. For example, secret key logic 250 may be configured to determine a secret key 284 (e.g., after reset or initialization, etc.) when a certain number of time intervals (t) (e.g., one or more) have been received or when a certain number of photons have been detected. The secret key 284 may be, for example, the (values of) time periods (t1-tn) themselves or a value derived from time periods (t1-tn).

Using embodiments of such an architecture then, photonics in the photonics layer may be tightly integrated with a processor (e.g., a CPU), including such integration on a single die. Embodiments may thus have the advantage of providing very small, low power, highly scalable performance that may be updatable (e.g., through software or firmware updates).

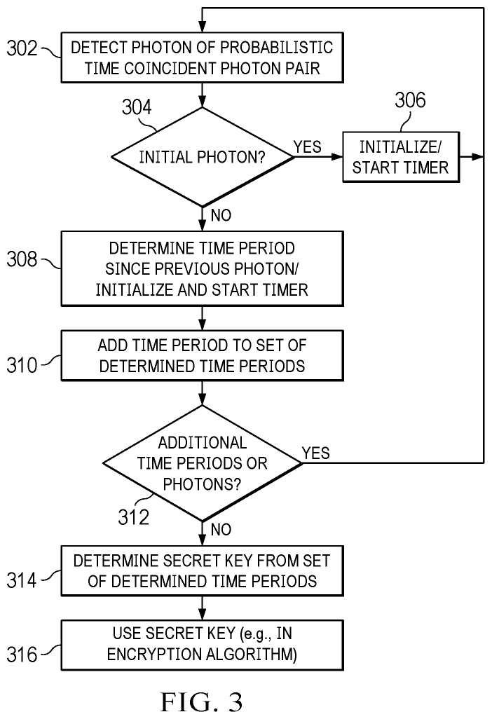

FIG. 3 depicts one embodiment of a method for QKD between two computing devices that may be implemented at one of the computing devices. Initially, a photon of a time coincident photon pair produced by a probabilistic photon pair source may be detected at the computing device (STEP 302). If this is a detection of an initial photon (e.g., the timer was not previously reset or running) (Y branch of STEP 304), a timer (e.g., counter) may be initialized (e.g., reset) and started (STEP 306) and no action may be taken until a detection of a subsequent photon (STEP 302).

If, however, the detected photon is not an initially detected photon (N branch of STEP 304) (e.g., the timer was previously reset and is running), a time period since the previously received photon can be determined and the timer may be initialized (e.g., reset) and started again (STEP 308). The determined time period may then be added to a set of one more determined time periods between photon detection (STEP 310). It can then be determined if additional time periods or photon detections are required (STEP 312). Such a determination may be made based on a configured number of time periods or photon detections for determination of a shared secret (which may be one or more time periods or two or more photon detections, etc.), such that both computing devices participating in QKD may be configured with the same number of time periods or photon detections.

If additional time periods or photon detections are required (Y branch of STEP 312) no further action may be taken until a detection of a subsequent photon (STEP 302). If, however, no additional time periods or photon detections are needed (N branch of STEP 312), a shared secret may be determined based on the set of determined time periods (STEP 314). This shared secret may be the values of the determined time periods themselves or a value derived from those time periods. This shared secret can then be used as the basis for the implementation of cryptographic security measures implemented in association with the other computing device (e.g., encryption of data passing between the computing devices) (STEP 316).

Finally, it should be noted that the embodiments described above may not provide complete protection against man-in-the-middle attacks. However, by transmitting a pair of cryptographic signatures (one for Alice to send to Bob and one for Bob to send to Alice) for each exchanged secret, then the likelihood of a successful man-in-the-middle attack may be significantly reduced. Such signatures can be calculated using either standard Asymmetric cryptographic methods or by using Symmetric cryptography. For the asymmetric crypto-based embodiments, well-known Public-Key mechanisms such as RSA or ECC-based signatures and other equivalent methods may be used. In addition, newer, Post-Quantum-Cryptography (PQC), signature algorithms may also be utilized. For the symmetric crypto case, signatures based on previously-shared secret keys may be used.

Although the invention has been described with respect to specific embodiments thereof, these embodiments are merely illustrative, and not restrictive of the invention. The description herein of illustrated embodiments of the invention, including the description in the Summary, is not intended to be exhaustive or to limit the invention to the precise forms disclosed herein (and in particular, the inclusion of any particular embodiment, feature or function within the Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein and throughout the claims that follow, the meaning of “in” includes “in” and “on” unless the context clearly dictates otherwise.

What is claimed is:

1. A system for a Quantum Key Distribution (QKD), comprising:
a first computing device, including:
a first photodetector adapted to detect first photons of a set of photon pairs and generate first detection events for each of the detected first photons, wherein the set of photon pairs were produced by a photon pair source adapted to probabilistically generate the set photon pairs and each photon pair comprises a time coincident first photon and second photon;
first interval determination logic adapted to receive the first detection events from the first photodetector and generate a first set of time periods based on time periods between received first detection events; and
first secret key logic adapted to receive the first set of time periods and generate a first secret key based on the received first set of time periods.

2. The system of claim 1, wherein the photon pair source is coupled to a second computing device via a waveguide, the second computing device comprising:
a second photodetector adapted to detect the second photons of the set of photon pairs and generate second detection events for each of the detected second photons;
second interval determination logic adapted to receive the second detection events from the second photodetector and generate a second set of time periods based on time periods between received second detection events; and
second secret key logic adapted to receive the second set of time periods and generate a second secret key based on the received set of time periods.

3. The system of claim 2, wherein the first photodetector is a single photon avalanche diode.

4. The system of claim 1, wherein the first computing device includes the photon pair source.

5. The system of claim 1, wherein the photon pair source is remote from both the first computing device and the second computing device.

6. The system of claim 1, wherein the photon pair source creates the set of photon pairs using spontaneous parametric down conversion or four wave mixing.

7. The system of claim 1, wherein the photon pair source is a nano ring based photon pair generator.

8. A method for Quantum Key Distribution (QKD), comprising:
at a first computing device:
detecting first photons of a probabilistically generated set of photon pairs, the first photons time coincident with corresponding second photons of the set of photon pairs;
generating a first set of time periods based on time periods between detection of the first photons of the set of photon pairs; and
generating a first secret key based on the received first set of time periods.

9. The method of claim 8, further comprising:
at a second computing device:
detecting the corresponding second photons of the set of photon pairs;
generating a second set of time periods based on time periods between detection of the second photons of the set of photon pairs; and
generating a second secret key based on the received first set of time periods.

10. The method of claim 9, wherein the set of photon pairs are generated at the first computing device.

11. The method of claim 10, further comprising, providing the corresponding second photons from the first computing device to the second computing device.

12. The method of claim 11, wherein the second photons are provided to the second computing device over a link between the first computing device and the second computing device.

13. The method of claim 12, further comprising sending a health monitor signal between the first computing device and second computing device.

14. The method of claim 13, wherein the health monitor signal is a classic signal sent over the link between the first computing device and the second computing device.

15. The method of claim 9, further comprising encrypting or decrypting data sent between the first computing device and second computing device based on the first secret key or the second secret key.

16. The method of claim 9, further comprising checking the first secret key against the second secret key.

17. The method of claim 16, wherein the first secret key is checked against the second secret key by creating a first hash value from the first secret key and a second hash value using the second secret key and comparing the first hash value and the second hash value.

18. The method of claim 16, further comprising maintaining a first candidate list of secret keys at the first computing device and a second candidate list of secret keys at the second computing device, wherein the first secret key is checked against the second secret key based on the first candidate list or second candidate list.

19. The method of claim 9, wherein a number of the first photons or second photons, or a number of the first set of time periods or second set of time periods, is configured at the first computing device and the second computing device.
